(19) United States
(12) Patent Application Publication
(10) Pub. No.: US 2025/0310950 A1
(43) Pub. Date: Oct. 2, 2025

(54) METHOD AND DEVICE FOR TRANSMITTING OR RECEIVING SIGNAL IN WIRELESS COMMUNICATION SYSTEM

(71) Applicant: LG ELECTRONICS INC., Seoul (KR)

(72) Inventor: Gyeongcheol LEE, Seoul (KR)

(21) Appl. No.: 18/861,778

(22) PCT Filed: May 12, 2023
(86) PCT No.: PCT/KR2023/006484

§ 371 Date: Oct. 30, 2024

Related U.S. Application Data
(60) Provisional application No. 63/340,944, filed on May 12, 2022.

(51) Int. Cl. H04W 72/11

(52) U.S. Cl. CPC H04W 72/11

(57) ABSTRACT

A method and apparatus for performing operations in a wireless communication system disclosed herein may transmit/receive data on a CG occasion of at least one shared CG associated with a SPS.

### CROSS-REFERENCE TO RELATED APPLICATIONS

This application is a National Phase application under 35 U.S.C. 371 of International Application No. PCT/KR2023/006484, filed on May 12, 2023, which claims the benefit of U.S. Provisional Application No. 63/340,944, filed on May 12, 2022, the contents of which are incorporated by reference herein in their entirety.

### TECHNICAL FIELD

The present disclosure relates to a method and apparatus for use in a wireless communication system.

### BACKGROUND

Generally, a wireless communication system is developing to diversely cover a wide range to provide such a communication service as an audio communication service, a data communication service and the like. The wireless communication is a sort of a multiple access system capable of supporting communications with multiple users by sharing available system resources (e.g., bandwidth, transmit power, etc.). For example, the multiple access system may include one of code division multiple access (CDMA) system, frequency division multiple access (FDMA) system, time division multiple access (TDMA) system, orthogonal frequency division multiple access (OFDMA) system, single carrier frequency division multiple access (SC-FDMA) system, and the like.

### SUMMARY

The object of the present disclosure is to provide a method and apparatus for transmitting and receiving signals efficiently in a wireless communication system.

It will be appreciated by persons skilled in the art that the objects that could be achieved with the present disclosure are not limited to what has been particularly described hereinabove and the above and other objects that the present disclosure could achieve will be more clearly understood from the following detailed description.

The present disclosure provides a method and apparatus for transmitting and receiving a signal in a wireless communication system.

In an aspect of the present disclosure, there is provided a method for performing operations of a User Equipment (UE) in a wireless communication system. The method may include: configuring a first semi-persistent scheduling (SPS), a second SPS, and at least one shared configured grant (CG), wherein the first SPS is associated with the at least one shared CG; based on receiving a first medium access control (MAC) protocol data unit (PDU) on a first SPS occasion of the first SPS, transmitting a first uplink (UL) data on a CG occasion of the at least one shared CG; and based on receiving the first MAC PDU on a second SPS occasion of the second SPS, transmitting a second UL data on a UL grant which is not given by the at least one shared CG.

In other aspects of the present disclosure, an apparatus, a processor and a storage medium for performing the signal monitoring method are provided.

The communication apparatus may include an autonomous driving vehicle communicable with at least a UE, a network, and another autonomous driving vehicle other than the communication apparatus.

The above-described aspects of the present disclosure are only some of the preferred embodiments of the present disclosure, and various embodiments reflecting the technical features of the present disclosure may be derived and understood from the following detailed description of the present disclosure by those skilled in the art.

According to an embodiment of the present disclosure, a communication apparatus may transmit and receive signals more efficiently in a different way from the prior art.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF DRAWINGS

FIG. 1 illustrates a radio frame structure.

FIG. 2 illustrates a resource grid during the duration of a slot.

FIG. 3 illustrates a self-contained slot structure.

FIGS. 4 to 6 are diagrams for explaining embodiments of the present disclosure.

FIGS. 7 to 10 show an example of apparatuses according to an embodiment of the present disclosure.

### DETAILED DESCRIPTION

The following technology may be used in various wireless access systems such as code division multiple access (CDMA), frequency division multiple access (FDMA), time division multiple access (TDMA), orthogonal frequency division multiple access (OFDMA), single carrier frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/enhanced data rates for GSM evolution (EDGE). OFDMA may be implemented as a radio technology such as institute of electrical and electronics engineers (IEEE) 802.11 (wireless fidelity (Wi-Fi)), IEEE 802.16 (worldwide interoperability for microwave access (WiMAX)), IEEE 802.20, evolved UTRA (E-UTRA), and so on. UTRA is a part of universal mobile telecommunications system (UMTS). 3rd generation partnership project (3GPP) long term evolution (LTE) is a part of evolved UMTS (E-UMTS) using E-UTRA, and LTE-advanced (LTE-A) is an evolution of 3GPP LTE. 3GPP new radio or new radio access technology (NR) is an evolved version of 3GPP LTE/LTE-A.

For clarity of description, the present disclosure will be described in the context of a 3GPP communication system (e.g., LTE and NR), which should not be construed as limiting the spirit of the present disclosure. LTE refers to a technology beyond 3GPP TS 36.xxx Release 8. Specifically, the LTE technology beyond 3GPP TS 36.xxx Release 10 is called LTE-A, and the LTE technology beyond 3GPP TS 36.xxx Release 13 is called LTE-A pro. 3GPP NR is the technology beyond 3GPP TS 38.xxx Release 15. LTE/NR may be referred to as a 3GPP system. “xxx” specifies a technical specification number. LTE/NR may be generically referred to as a 3GPP system. For the background technology, terminologies, abbreviations, and so on as used herein, refer to technical specifications published before the present disclosure. For example, the following documents may be referred to.

3GPP NR
38.211: Physical channels and modulation
38.212: Multiplexing and channel coding
38.213: Physical layer procedures for control
38.214: Physical layer procedures for data
38.300: NR and NG-RAN Overall Description
38.331: Radio Resource Control (RRC) protocol specification

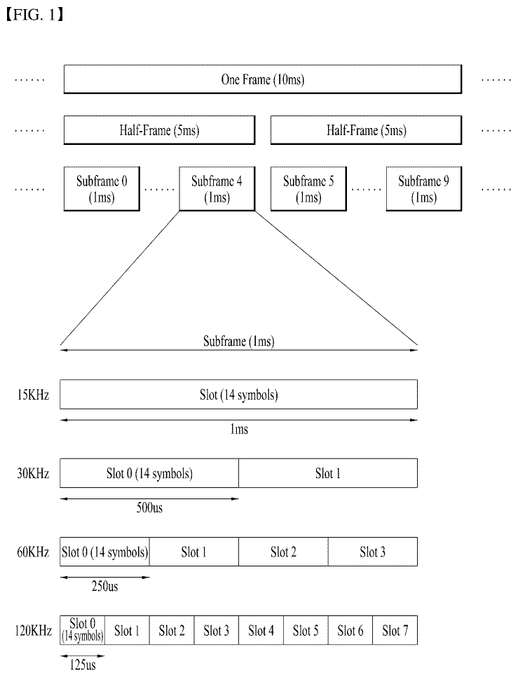

FIG. 1 illustrates a radio frame structure used for NR.

In NR, UL and DL transmissions are configured in frames. Each radio frame has a length of 10 ms and is divided into two 5-ms half-frames. Each half-frame is divided into five 1-ms subframes. A subframe is divided into one or more slots, and the number of slots in a subframe depends on a subcarrier spacing (SCS). Each slot includes 12 or 14 OFDM (A) symbols according to a cyclic prefix (CP). When a normal CP is used, each slot includes 14 OFDM symbols. When an extended CP is used, each slot includes 12 OFDM symbols. A symbol may include an OFDM symbol (or a CP-OFDM symbol) and an SC-FDMA symbol (or a discrete Fourier transform-spread-OFDM (DFT-s-OFDM) symbol).

Table 1 exemplarily illustrates that the number of symbols per slot, the number of slots per frame, and the number of slots per subframe vary according to SCSs in a normal CP case.

TABLE 1

| SCS (15*2\hat{ }u) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

*N^{slot}_{symb}: number of symbols in a slot
*N^{frame, u}ₛₗₒₜ: number of slots in a frame
*N^{subframe, u}ₛₗₒₜ: number of slots in a subframe

Table 2 illustrates that the number of symbols per slot, the number of slots per frame, and the number of slots per subframe vary according to SCSs in an extended CP case.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

In the NR system, different OFDM (A) numerologies (e.g., SCSs, CP lengths, and so on) may be configured for a plurality of cells aggregated for one UE. Accordingly, the (absolute time) duration of a time resource (e.g., a subframe, a slot, or a transmission time interval (TTI)) (for convenience, referred to as a time unit (TU)) composed of the same number of symbols may be configured differently between the aggregated cells.

In NR, various numerologies (or SCSs) may be supported to support various 5th generation (5G) services. For example, with an SCS of 15 kHz, a wide area in traditional cellular bands may be supported, while with an SCS of 30 kHz or 60 kHz, a dense urban area, a lower latency, and a wide carrier bandwidth may be supported. With an SCS of 60 kHz or higher, a bandwidth larger than 24.25 kHz may be supported to overcome phase noise.

An NR frequency band may be defined by two types of frequency ranges, FR1 and FR2. FR1 and FR2 may be configured as described in Table 3 below. FR2 may be millimeter wave (mmW).

TABLE 3

| Frequency Range | Corresponding frequency | |
|---|---|---|
| designation | range | Subcarrier Spacing |
| FR1 | 450 MHz-7125 MHz | 15, 30, 60 kHz |
| FR2 | 24250 MHz-52600 MHz | 60, 120, 240 kHz |

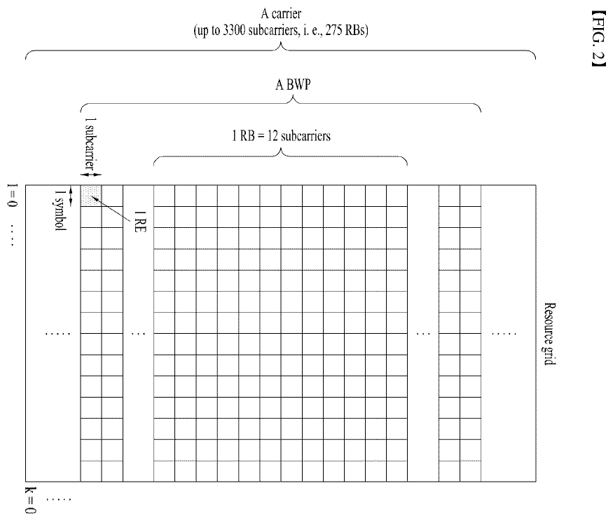

FIG. 2 illustrates a resource grid during the duration of one slot.

A slot includes a plurality of symbols in the time domain. For example, one slot includes 14 symbols in a normal CP case and 12 symbols in an extended CP case. A carrier includes a plurality of subcarriers in the frequency domain. A resource block (RB) may be defined by a plurality of (e.g., 12) consecutive subcarriers in the frequency domain. A plurality of RB interlaces (simply, interlaces) may be defined in the frequency domain. Interlace m∈{0, 1, . . . , M−1} may be composed of (common) RBs {m, M+m, 2M+m, 3M+m, . . . }. M denotes the number of interlaces. A bandwidth part (BWP) may be defined by a plurality of consecutive (physical) RBs ((P) RBs) in the frequency domain and correspond to one numerology (e.g., SCS, CP length, and so on). A carrier may include up to N (e.g., 5) BWPs. Data communication may be conducted in an active BWP, and only one BWP may be activated for one UE. Each element in a resource grid may be referred to as a resource element (RE), to which one complex symbol may be mapped.

In a wireless communication system, a UE receives information from a BS in downlink (DL), and the UE transmits information to the BS in uplink (UL). The information exchanged between the BS and UE includes data and various control information, and various physical channels/signals are present depending on the type/usage of the information exchanged therebetween. A physical channel corresponds to a set of resource elements (REs) carrying information originating from higher layers. A physical signal corresponds to a set of REs used by physical layers but does not carry information originating from the higher layers. The higher layers include a medium access control (MAC) layer, a radio link control (RLC) layer, a packet data convergence protocol (PDCP) layer, a radio resource control (RRC) layer, and so on.

DL physical channels include a physical broadcast channel (PBCH), a physical downlink shared channel (PDSCH), and a physical downlink control channel (PDCCH). DL physical signals include a DL reference signal (RS), a primary synchronization signal (PSS), and a secondary synchronization signal (SSS). The DL RS includes a demodulation reference signal (DM-RS), a phase tracking reference signal (PT-RS), and a channel state information reference signal (CSI-RS). UL physical channel include a physical random access channel (PRACH), a physical uplink shared channel (PUSCH), and a physical uplink control channel (PUCCH). UL physical signals include a UL RS. The UL RS includes a DM-RS, a PT-RS, and a sounding reference signal (SRS).

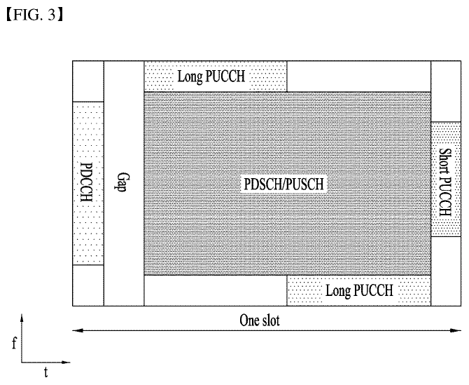

FIG. 3 illustrates a structure of a self-contained slot.

In the NR system, a frame has a self-contained structure in which a DL control channel, DL or UL data, a UL control channel, and the like may all be contained in one slot. For example, the first N symbols (hereinafter, DL control region) in the slot may be used to transmit a DL control channel, and the last M symbols (hereinafter, UL control region) in the slot may be used to transmit a UL control channel. N and M are integers greater than or equal to 0. A resource region (hereinafter, a data region) that is between the DL control region and the UL control region may be used for DL data transmission or UL data transmission. For example, the following configuration may be considered. Respective sections are listed in a temporal order.

In the present disclosure, a base station (BS) may be, for example, a gNode B (gNB).

### Embodiment 1: Controlled Shared CG by SPS

The above-described contents (NR frame structure, etc.) may be applied in combination with methods proposed in the present specification to be described below, or may be supplemented to clarify the technical features of the methods proposed in the present specification.

Methods related to the NR system or LTE system described above, and needless to say, the technological spirit proposed in the present specification may be modified or replaced according to the term, expression, structure, etc. defined in each system to be implemented in the corresponding system.

In NR, to support URLLC (Ultra-Reliable and Low Latency Communications) service, a dedicated CG (configured grant) and SPS (semi-persistent scheduling) can be excessively used and even multiple CG and SPS configurations are allowed to be configured to support very short interval or non-integer periodicity of a user traffic. This means that many dedicated CG and SPS configurations may need to be configured to support only one application service. Considering that lots of new services which may need many CG and/or SPS configurations are introduced and developing, it would be impossible to allocate all required dedicated CG and SPS configurations for each UE in a cell and only limited number of services can be provided to a UE by one gNB. This may be a limitation and critical barrier to extend service coverage and enhance scheduling performance in a network.

A shared CG may be considered to relieve this limitation. However, if a CG is shared by multiple UEs, transmission collision in a CG grant may not be avoided and occur frequently since each CG grant can be freely used by multiple UEs. This transmission collision will increase transmission delay of each data for a URLLC service and finally a user service may not be served properly due to this unexpected latency in the shared CG. In other words, the shared CG can make more UEs use more CG resources, but it may cause long delay and may not be helpful for the URLLC service due to transmission collision. To overcome this unexpected latency due to collision and provide more URLLC services with the less number of dedicated CG, a new mechanism should be considered to increase efficiency of the shared CG and the dedicated CG.

Embodiment 1 is related to a UE configured with a first SPS, a second SPS, and at least one CG. The first SPS is associated to one CG among the at least one CG and the second SPS is not associated with any CG among the at least one CG. When the UE receives a MAC (medium access control) PDU (protocol data unit) from the network, the UE checks whether the MAC PDU is received using the first SPS or not. If the UE receives the MAC PDU using the first SPS and a data from an upper layer, the UE transmits the data using the associated CG among the at least one CG. If the UE receives the MAC PDU using the second SPS and a data from an upper layer, the UE transmits the data using the dynamic UL grant or the UL grant which is not given by the CG associated with the SPS.

The UE is configured with at least one CG including a configuration to make the UE use a CG grant periodically. A CG grant given by the CG configuration may be available after activating the CG configuration and unavailable after deactivating the CG configuration. If the at least one CG is dedicatedly configured to the UE, only one UE can use the at least one CG. If the at least one CG is shared by multiple UEs, the multiple UEs may have same CG configuration. If the multiple UEs try to send a data on the CG grant simultaneously, transmission collision may occur on this CG grant.

The UE is configured with at least one SPS including configurations to make the UE receive a SPS assignment periodically. A SPS assignment in a SPS configuration may be available after activating the SPS configuration and unavailable after deactivating the SPS configuration. Each CG and/or SPS configuration may have an index which can be used to distinguish each CG and/or SPS in one MAC entity or one UE. The UE may be configured with an association between the at least one SPS and the at least one CG. One SPS configuration may be associated with one or more CG configuration.

A MAC PDU received on the at least one SPS or L1 (layer-1, physical layer) signalling may include the index of CG configuration. If the index of CG configuration is included, the UE transmits the data on the indicated CG after generating a MAC PDU which may only include a data from the logical channel associated with the indicated CG and/or SPS.

One CG configuration may be associated with one or more SPS configuration. Each CG and/or SPS configuration may be associated with a logical channel. If one logical channel is associated with both the CG configuration and the SPS configuration, the UE can implicitly recognize the association between the at least one CG and the at least one SPS. Therefore, the UE can recognize the CG associated with the SPS where is used for receiving the MAC PDU.

Activation/deactivation of CG and/or SPS can be indicated by L1/L2/L3 signalling. The UE receives a SPS and CG configuration using RRC, L2 signalling, or pre-configured. The association between the SPS and the CG can be configured or modified by RRC or L1/L2 signalling, L3 signalling may include RRC signalling. L1 signalling may include DCI (downlink control information). L2 signalling may include MAC CE (control element) and/or control PDU.

The UE may be configured with a duration (shared CG occupying duration) for the at least one CG. The UE may be allowed to use the at least one CG only during this duration. The duration can be pre-configured, semi-statically configured, or dynamically changed. If the duration is semi-statically or dynamically changed, the duration information may be given before or during receiving a MAC PDU on the at least one SPS. The duration can be configured per LCH (logical channel), per CG/SPS, per MAC, or per UE. The duration may be one of followings:
Exact time duration, e.g., 1 or 2 msec;
Length of symbols/slots/subframes, it may consecutively occurs;
The number of CG grants, it may consecutively occurs;
The number of associated SPS assignments, it may consecutively occurs;

When the UE receives the MAC PDU using one SPS among the at least one SPS, the UE checks whether the one SPS among the at least one SPS is associated with the at least one CG.
If the one SPS among the at least one SPS is associated with one CG among the at least one CG and the UE has a data to transmit, the UE generates a data PDU including the data and transmits the data PDU to the network (or a base station) using a UL grant given by the one CG associated with the one SPS used for receiving the MAC PDU.
If the one SPS among the at least one SPS is not associated with the at least one CG and the UE has a data to transmit, the UE generates a data PDU including the data and transmits the data PDU to the network (or the base station) using a UL grant which is not given by the one CG that has an association with the at least one SPS. Wherein the UL grant may be given by a CG among the at least one CG which is not associated with any SPS among the at least one SPS. Wherein the UL grant may be a dynamic UL grant given by the network.
If the one SPS is associated with multiple CGs among the at least one CG, the UE may generate a data PDU including the data and transmit the data PDU to the network (or the base station) using one of multiple CGs. Wherein the UE may choose the earliest CG, the largest CG, or the smallest CG grant among multiple CGs. Alternatively, the UE may use all CG grants of multiple CGs. Wherein the UE may transmit the same data PDU on the all CG grants of multiple CGs or the UE may transmit a different data PDU for each CG grant among all CG grants.

If the UE receives the MAC PDU using the at least one SPS which has an association with the at least one CG, the data PDU may include the data at least or only from a logical channel associated with the at least one CG and/or the at least one SPS. Even if data is available in the LCH which is associated with the at least one CG before receiving the MAC PDU using the at least one SPS, the UE may not be allowed to transmit the data using the CG grant of the at least one CG until the UE receives the MAC PDU using the at least one SPS which has an association with the at least one CG. Wherein even though the data is arrived at the logical channel associated with the at least one CG which has an association with the at least one SPS, the UE cannot use the CG grant of the at least one CG until the UE receives the MAC PDU on the at least one SPS associated with the at least one CG and the UE may trigger and transmit an indication to the network to request UL grants after receiving the data from the upper layer.

When the UE receives the MAC PDU using the one SPS among the at least one SPS, the UE may start or restart a timer for the one CG associated with the one SPS. Alternatively, the UE may start or restart the timer when the UE generates and/or transmits the data PDU for the one CG associated with the one SPS among the at least one SPS. The UE may be allowed to use the associated CG only during the timer running. If the timer stops or expires, the UE may consider the one CG associated with the one SPS among the at least one SPS is not available. If there are remaining data available for transmission after stopping or expiring the timer, the UE may transmit a buffer status report or an indication to indicate that the UE has remaining data for transmission to the network. Wherein the data transmission may be allowed only after receiving the MAC PDU from the first SPS or the second SPS.

When the UE receives the MAC PDU using the one SPS among the at least one SPS, if the at least one CG associated with the one SPS is not activated, the UE may activate the at least one CG associated with the one SPS and then the UE transmits the data PDU using this activated CG which is associated with the one SPS.

The example is given in FIG. 4. It is assumed that the SPS1 is associated with the CG1 and the SPS2 is not associated with any CGs. Both SPS1 and SPS2 are dedicatedly configured to the UE. The CG1 is shared by other UEs and the UE can use the CG grant of the CG1 after receiving a MAC PDU on the associated SPS1. The CG2 is dedicatedly configured to the UE and the CG grant of CG2 can be used by the UE when the data is available for transmission. It is also supposed that the LCH1 is associated with the CG1 and the LCH2 is associated with the CG2, but LCH3 is not associated with any CGs. The time duration for the CG1 is two consecutive CG grants of the CG1. The buffer status of LCH 1/2/3 is assumed as shown in FIG. 4(a) upon receiving the MAC PDU B1.

When the UE receives the MAC PDU B1 using the SPS2 from the network, the UE recognizes the SPS2 is not associated with any CGs and does not start a timer for CG1. Even though the CG grant C1 is the earliest available CG grant, the UE does not use the CG grant C1 to transmit the PDUs from LCH2/3 because the CG1 is associated with the SPS1. The CG grant C1 is skipped since the timer is not running for CG1 and the MAC PDU using the SPS1 is not received yet even if the LCH1 has data for transmission. The PDU3 in LCH2 is transmitted using the CG grant D1 of CG2 and the PDU4 in LCH2 is transmitted using the received dynamic grant E1 from the network because this dynamic grant E1 is the next earliest available UL grant. The PDU5 in LCH3 is transmitted using the CG grant D2 of CG2 because this is not associated with any CGs and satisfies the LCP (Logical Channel Prioritization) restriction of the CG grant D2. The CG grant D3 of CG2 is skipped due to no data available for transmission at this CG grant occasion.

When the UE receives the MAC PDU A1 using the SPS1 from the network, the UE recognizes the SPS1 is associated with the CG1 and (re) start a timer for CG1. The timer value may be two CG grants of CG1. And the timer for CG1 may be (re) started when the PDU is transmitted on the CG grant of CG1. Even though the dynamic grant E1 occurs earlier than the CG grant C2, the UE cannot use the dynamic grant E1 to transmit the PDUs from LCH1 because the SPS1 is associated with the CG1. The PDU1 in LCH1 is transmitted using the CG grant C2 of CG1 and the PDU2 in LCH1 is transmitted using the CG grant C3 of CG1. The timer for CG1 may expire upon transmitting the PDU 2 because the timer value is two CG grants of CG1. When the UE transmits the PDU2, the UE can recognize the LCH1 still having data for transmission, i.e., PDU6, after transmitting the PDU2. And the UE can trigger/include a buffer status report into the MAC PDU which is used for transmitting the PDU2. Alternatively, The UE may can trigger/transmit an indication to the network to indicate that the PDU6 is still in the LCH1 using a L1 channel, e.g., PUCCH, or L2 signalling. Even though the PDU6 is still in the LCH1 after transmitting the PDU2, the UE cannot transmit the PDU6 using the upcoming CG grant of CG1 until the next MAC PDU is received on the SPS1.

According to Embodiment 1, the UE can avoid transmission collision on the shared CG using an association with the dedicated SPS and the shared CG which can increase scheduling efficiency in the network, i.e., the network can serve same number of UEs without transmission collision using the smaller number of dedicated CG and shared CG resource. This can also reduce power consumption of the UE since the smaller number of CGs may be used to support one service.

### Embodiment 1-1: Mapping Between CG and SPS for Interactive Service

Interactive service based on edge computing is recently developing to serve human being in many place such as a public place, a restaurant, a home, and etc. In this type of the service, the main computing is carried by an edge server probably located in an access network (e.g., along with gNB or nearby gNB) and the device may have a simple input/output interface like display panel to communicate with a human being. Another example is a connected robot which has a connection to an edge server and all commands are given by the edge server. Cloud game can be also another example.

One common characteristic of an interactive service is time critical service which requires data to be arrived at the destination in time or on time. For this, configured grant (CG) and Semi-Persistent Scheduling (SPS) can be actively used to reduce scheduling latency and satisfy latency requirement. In addition, it is very like to generate uplink data in response of downlink data in the interactive service and the required QoS (quality of service) of uplink and downlink data in one interactive service may be same or similar.

In NR, CG and SPS has no association and each CG or SPS resource is operated independently. A UE can use the earliest CG resource to transmit a data which can satisfy LCP restriction for this earliest CG resource. In this condition, many CGs and SPSes should be excessively configured to support non-integer periodicity and a various QoS of the interactive service. However, actually all configured CG and SPS resources may not be always used and lots of uplink and downlink radio resources would be wasted unnecessarily. To overcome this problem, each CG and SPS can be configured with proper resource size and periodicity considering the related QoS, but the problem may still not be resolved because anyway the earliest CG can be used regardless of whether this earliest CG is configured for the transmitting data or not so long as the transmitting data pass the LCP restriction. If this earliest CG is used, the CG timer for the used HARQ will be started and the corresponding HARQ process for this CG cannot be used until the CG timer expires. This means that when the uplink data is generated after receiving downlink data for a specific interactive service, this uplink data may not be transmitted on time since all HARQ processes may be already occupied by other traffic. Finally, the interactive service will not be properly provided to the UE. Considering recently increasing interest on the interactive service, it should be a serious problem and this properly resolved to support interactive service smoothly in NR.

Interactive service based on edge computing is recently developing to serve human being in many place such as a public place, a restaurant, a home, and etc. In this type of the service, the main computing is carried by an edge server probably located in an access network (e.g., along with gNB or nearby gNB) and the device may have a simple input/output interface like display panel to communicate with a human being. Another example is a connected robot which has a connection to an edge server and all commands are given by the edge server. Cloud game can be also another example.

One common characteristic of an interactive service is time critical service which requires data to be arrived at the destination in time or on time. For this, configured grant (CG) and Semi-Persistent Scheduling (SPS) can be actively used to reduce scheduling latency and satisfy latency requirement. In addition, it is very like to generate uplink data in response of downlink data in the interactive service and the required QoS of uplink and downlink data in one interactive service may be same or similar.

In NR, CG and SPS has no association and each CG or SPS resource is operated independently. A UE can use the earliest CG resource to transmit a data which can satisfy LCP restriction for this earliest CG resource. In this condition, many CGs and SPSes should be excessively configured to support non-integer periodicity and a various QoS of the interactive service. However, actually all configured CG and SPS resources may not be always used and lots of uplink and downlink radio resources would be wasted unnecessarily. To overcome this problem, each CG and SPS can be configured with proper resource size and periodicity considering the related QoS, but the problem may still not be resolved because anyway the earliest CG can be used regardless of whether this earliest CG is configured for the transmitting data or not so long as the transmitting data pass the LCP restriction. If this earliest CG is used, the CG timer for the used HARQ will be started and the corresponding HARQ process for this CG cannot be used until the CG timer expires. This means that when the uplink data is generated after receiving downlink data for a specific interactive service, this uplink data may not be transmitted on time since all HARQ processes may be already occupied by other traffic. Finally, the interactive service will not be properly provided to the UE. Considering recently increasing interest on the interactive service, it should be a serious problem and this properly resolved to support interactive service smoothly in NR.

Embodiment 1-1 is related to a UE configured with a first SPS, a second SPS, a first CG, and a second CG. Since Embodiment 1 is related to the UE configured with the first SPS, the second SPS, the at least one CG (a first CG and a second CG), Embodiment 1-1 is part of Embodiment 1 and operations of Embodiment 1-1 can be combined with operations of Embodiment 1. Wherein the first SPS is associated to the first CG and the second SPS is associated to the second CG. When the UE receives a data from an upper layer and a MAC PDU from the network, the UE checks which SPS between the first SPS or the second SPS is used to receive the MAC PDU. If the MAC PDU is received using the first SPS, the UE transmits the data using the first CG. If the MAC PDU is received using the second SPS, the UE transmits the data using the second CG.

The UE is configured with at least one SPS and at least one CG. The UE may receive a same size of SPS assignment periodically from the network by one SPS configuration. The same size of CG grant to transmit a data to the network occurs periodically by one CG configuration. One CG among the at least one CG may be associated with the at least one SPS. One SPS among the at least one SPS may be associated with the at least one CG. Each SPS in the at least one SPS may have different configuration and each CG in the at least one CG may have different configuration. One CG and the associated SPS may have same or similar configuration. The UE receives SPS and CG configurations using RRC, L2 signalling, or pre-configured. The association between the SPS and the CG can be configured or modified by RRC or L2 signaling, e.g., MAC CE or control PDU.

When the UE receives a MAC PDU using one SPS among the at least one SPS, the UE checks which CG among the at least one CG is associated with the one SPS among the at least one SPS.

If the one SPS among the at least one SPS has the association with one CG among the at least one CG and the UE has a data to transmit, the UE transmits the data to the network using the one CG among the at least one CG which is associated with the one SPS used for receiving the MAC PDU.

If the one SPS has associations with multiple CGs among the at least one CG, the UE may transmit the data to the network using one of multiple CGs among the at least one CG. In this condition, the UE may choose the earliest CG or the largest/smallest grant among multiple CGs. If the data size is large enough, the UE may use all CG grants of multiple CGs.

If there is no association between the one SPS among the at least one SPS and the CG among the at least one CG and the UE has a data to transmit, the UE transmits the data using the dynamic grant from the network, not using the CG among the at least one CG or alternatively the UE transmits the data using any CG among the at least one CG. This UE behavior may be configured by the network explicitly or implicitly.

When the UE receives the MAC PDU using one SPS among the at least one SPS, if the associated CG is not activated, the UE may activate the associated CG or all CGs among the at least one CG, then the UE transmits the data using the activated CG which is associated with the SPS used for the MAC PDU. When the UE receives a SPS activation/deactivation command for the one SPS among the at least one SPS, the UE may activate/deactivate a CG among the at least one CG which is associated to the one SPS among the at least one SPS activated/deactivated by the received SPS activation/deactivation command. When the UE receives a CG activation/deactivation command for the one CG among the at least one CG, the UE may activate/deactivate a SPS among the at least one SPS which is associated to the one CG among the at least one CG activated/deactivated by the received CG activation/deactivation command.

When the UE receives the MAC PDU using one SPS among the at least one SPS, the UE may be allowed to use the one CG among the at least one CG for a duration after receiving the MAC PDU on the one SPS among the at least one SPS. The duration can be time duration, the number of CG resources, the number of system subframe. The UE may start a timer when the data is transmitted to the network using the one CG resource among the at least one CG or when the MAC PDU is received from the network using the one SPS among the at least one SPS. If the timer expires, the UE may not transmit a data using the one CG among the at least one CG even if the UE has a data available for transmission. The timer may be restarted whenever a MAC PDU is received using the one SPS among the at least one SPS.

Alternatively, one SPS among the at least one SPS may have an association with a LCH (logical channel). When the UE receives a MAC PDU using one SPS among the at least one SPS, the UE checks whether the one SPS among the at least one SPS has an association with which LCH. If the one SPS among the at least one SPS has an association with at least one LCH and the at least one LCH has a data available for transmission, the UE transmits the MAC PDU which only includes the data from the associated LCH using the CG which is associated with this LCH. When the UE transmits the MAC PDU, the CG which is associated with the LCH among the at least one CG may be used for transmission.

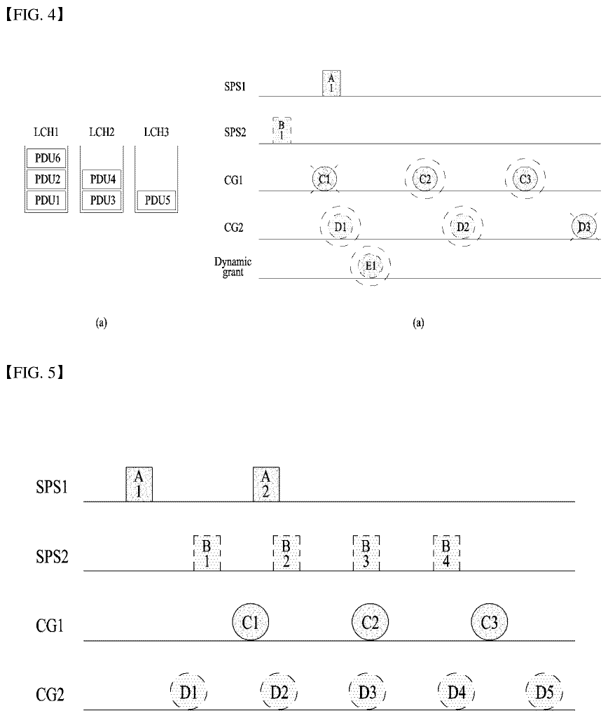

The example is given in FIG. 5. It is assumed that the SPS1 is associated with the CG 1 and the SPS2 is associated with the CG2. It is also assumed that the UE has a data available for transmission for CG1 and CG2 when the UE receives a MAC PDU using the SPS 1 or SPS2 from the network.

When the UE receives the MAC PDU A1 from the network and has data available for transmission, even though the CG grant D1 occurs after receiving the MAC PDU A1, the UE does not use the CG grant D1 because the CG2 is not associated with the SPS1. The UE transmits the data using CG grant C1 after receiving the MAC PDU A1.

When the UE receives the MAC PDU B1 from the network and has data available for transmission, even though the CG grant C1 occurs after receiving the MAC PDU B1, the UE does not use the CG grant C1 because the CG1 is not associated with the SPS2. The UE transmits the data using CG grant D2 after receiving the MAC PDU B1.

As the same policy is applied to all CG grants in the FIG. 5, the CG grant C2 is used after receiving the MAC PDU A2. The CG grant D3 is used after receiving the MAC PDU B2 and the CG grant D4 is used after receiving the MAC PDU B3 and the CG grant D5 is used after receiving the MAC PDU B4.

The CG grant C3 is skipped because there is no MAC PDU reception from the network using the SPS1. In this example, the UE may start/restart the timer upon each CG grant is used for data transmission or a MAC PDU reception.

According to Embodiment 1-1, the UE can associate between a CG and a SPS and then appropriate CG grant can be selectively used after receiving a MAC PDU on the SPS for an interactive service. The network can manage a pair of a CG and a SPS for supporting a specific QoS and it would be helpful for enhancing scheduling performance in the network.

Since examples of the above-described proposal method may also be included in one of implementation methods of the various embodiments, it is obvious that the examples are regarded as a sort of proposed methods. Although the above-proposed methods may be independently implemented, the proposed methods may be implemented in a combined (aggregated) form of a part of the proposed methods. A rule may be defined such that the BS informs the UE of information as to whether the proposed methods are applied (or information about rules of the proposed methods) through a predefined signal (e.g., a physical layer signal or a higher-layer signal). The higher layer may include, for example, one or more of functional layers such as MAC, RLC, PDCP, RRC, or SDAP.

Methods, embodiments, or descriptions for implementing the method proposed in the present specification may be separately applied or one or more methods (embodiments, or descriptions) may be combined and applied.

### Implementation Examples

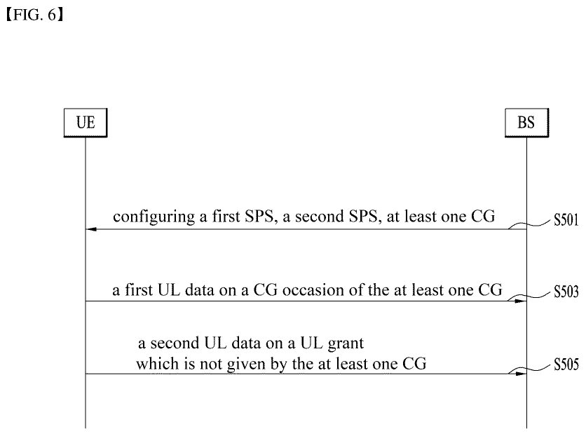

FIG. 6 is a flowchart of a signal transmission/reception method according to embodiments of the present disclosure.

Referring to FIG. 6, an embodiment performed by the UE may include: configuring a first SPS, a second SPS, and at least one shared CG (S601); transmitting a first UL data on a CG occasion of the at least one shared CG (S603); transmitting a second UL data on a UL grant which is not given by the at least one shared CG (S605). And, an embodiment performed by the BS may include: configuring a first SPS, a second SPS, and at least one shared CG to a UE (S601); receiving a first UL data on a CG occasion of the at least one shared CG (S603); receiving a second UL data on a UL grant which is not given by the at least one shared CG (S605).

The data transmission may be performed based on one or more of the operations described in the section of ‘Controlled shared CG by SPS’.

For example, referring to FIG. 4, the first SPS (SPS1) is associated with the at least one shared CG (CG1). Since the first SPS is associated with the at least one shared CG, in the step of S503, the first UL data (PDU1 and/or PDU2) is transmitted on the CG occasion (C2 and/or C3) of the at least one shared CG if a first MAC PDU is received on a first SPS occasion (A1) of the first SPS.

And, the second SPS (SPS2) is not associated with any CG (including the at least one shared CG). Therefore, in the step of S505, the second UL data (PDU3, PDU4, and/or PDU5) is transmitted on the UL grant (D1 and/or E1) if the first MAC PDU is received on a second SPS occasion (B1) of the second SPS. D1 is a CG occasion of dedicated CG (CG2), and E1 is a dynamic UL grant. The first data is not transmitted on CG occasions of the dedicated CG or dynamic UL grant even if there are the CG occasions of the dedicated CG and/or the dynamic UL grant earlier than CG occasions of the at least one shared CG. The second data is also not transmitted on CG occasions of the at least one shared CG even if there are the CG occasions of the at least one shared CG earlier than CG occasions of the dedicated CG and/or the dynamic UL grant.

Preferably, the first SPS and the at least one shared CG are associated with same logical channel.

The timer or duration for the at least one shared CG associated with the first SPS can be expressed as the shared CG occupying duration. The first data is transmitted within the shared CG occupying duration. The shared CG occupying duration is configured with the first SPS or is configured based on information received with the first MAC PDU or information included in the first MAC PDU.

If the shared CG occupying duration is expired, the UE does not transmit remaining data (PDU6) on the CG occasions of the at least one shared CG. Instead, the UE may trigger a BSR or transmit an indication for the remaining data.

Additionally, in the above description, the duration may be one of exact time duration, Length of symbols/slots/subframes, the number of CG grants, the number of associated SPS assignments. Therefore, the shared CG occupying duration can be configured as an absolute time duration, a length of at least one symbol, a length of at least one slot, a length of at least one subframe, a number of CG occasions of the at least one shared CG, and/or a number of first SPS occasions from the first SPS.

The shared CG occupying duration starts based on the reception of the MAC PDU on the SPS or based on the transmission of the first data on the at least one CG occasion.

The operations described with reference to FIG. 6 may be additionally performed in combination with at least one of the operations described with reference to FIGS. 1 to 5 and/or the operations described in Embodiment 1 and 1-1.

Example of Communication System to which the Present Disclosure is Applied

The various descriptions, functions, procedures, proposals, methods, and/or operation flowcharts of the present disclosure described herein may be applied to, but not limited to, various fields requiring wireless communication/connectivity (e.g., 5G) between devices.

More specific examples will be described below with reference to the drawings. In the following drawings/description, like reference numerals denote the same or corresponding hardware blocks, software blocks, or function blocks, unless otherwise specified.

FIG. 7 illustrates a communication system 1 applied to the present disclosure.

Referring to FIG. 7, the communication system 1 applied to the present disclosure includes wireless devices, BSs, and a network. A wireless device is a device performing communication using radio access technology (RAT) (e.g., 5G NR (or New RAT) or LTE), also referred to as a communication/radio/5G device. The wireless devices may include, not limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of vehicle-to-vehicle (V2V) communication. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television (TV), a smartphone, a computer, a wearable device, a home appliance, a digital signage, a vehicle, a robot, and so on.

The hand-held device may include a smartphone, a smart pad, a wearable device (e.g., a smart watch or smart glasses), and a computer (e.g., a laptop). The home appliance may include a TV, a refrigerator, a washing machine, and so on. The IoT device may include a sensor, a smart meter, and so on. For example, the BSs and the network may be implemented as wireless devices, and a specific wireless device 200a may operate as a BS/network node for other wireless devices.

The wireless devices 100a to 100f may be connected to the network 300 via the BSs 200. An AI technology may be applied to the wireless devices 100a to 100f, and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without intervention of the BSs/network. For example, the vehicles 100b-1 and 100b-2 may perform direct communication (e.g., V2V/vehicle-to-everything (V2X) communication). The IoT device (e.g., a sensor) may perform direct communication with other IoT devices (e.g., sensors) or other wireless devices 100a to 100f.

Wireless communication/connections 150a, 150b, and 150c may be established between the wireless devices 100a to 100f/BS 200 and between the BSs 200. Herein, the wireless communication/connections may be established through various RATs (e.g., 5G NR) such as UL/DL communication 150a, sidelink communication 150b (or, D2D communication), or inter-BS communication (e.g., relay or integrated access backhaul (IAB)). Wireless signals may be transmitted and received between the wireless devices, between the wireless devices and the BSs, and between the BSs through the wireless communication/connections 150a, 150b, and 150c. For example, signals may be transmitted and receive don various physical channels through the wireless communication/connections 150a, 150b and 150c. To this end, at least a part of various configuration information configuring processes, various signal processing processes (e.g., channel encoding/decoding, modulation/demodulation, and resource mapping/demapping), and resource allocation processes, for transmitting/receiving wireless signals, may be performed based on the various proposals of the present disclosure.

Example of Wireless Device to which the Present Disclosure is Applied

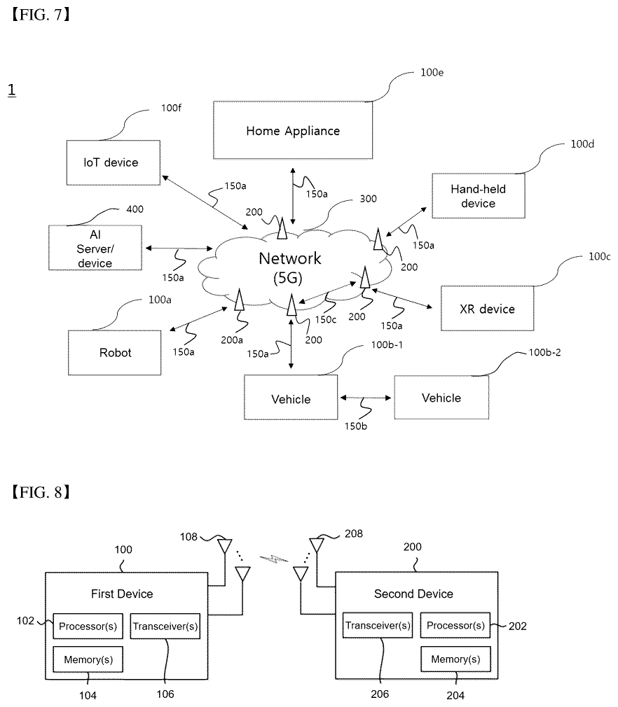

FIG. 8 illustrates wireless devices applicable to the present disclosure.

Referring to FIG. 8, a first wireless device 100 and a second wireless device 200 may transmit wireless signals through a variety of RATs (e.g., LTE and NR). {The first wireless device 100 and the second wireless device 200} may correspond to {the wireless device 100x and the BS 200} and/or {the wireless device 100x and the wireless device 100x} of FIG. 7.

The first wireless device 100 may include one or more processors 102 and one or more memories 104, and further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operation flowcharts disclosed in this document. For example, the processor(s) 102 may process information in the memory(s) 104 to generate first information/signals and then transmit wireless signals including the first information/signals through the transceiver(s) 106. The processor(s) 102 may receive wireless signals including second information/signals through the transceiver(s) 106 and then store information obtained by processing the second information/signals in the memory(s) 104. The memory(s) 104 may be connected to the processor(s) 102 and may store various pieces of information related to operations of the processor(s) 102. For example, the memory(s) 104 may store software code including instructions for performing all or a part of processes controlled by the processor(s) 102 or for performing the descriptions, functions, procedures, proposals, methods, and/or operation flowcharts disclosed in this document. The processor(s) 102 and the memory(s) 104 may be a part of a communication modem/circuit/chip designed to implement RAT (e.g., LTE or NR). The transceiver(s) 106 may be connected to the processor(s) 102 and transmit and/or receive wireless signals through the one or more antennas 108. Each of the transceiver(s) 106 may include a transmitter and/or a receiver. The transceiver(s) 106 may be interchangeably used with radio frequency (RF) unit(s). In the present disclosure, the wireless device may be a communication modem/circuit/chip.

The second wireless device 200 may include one or more processors 202 and one or more memories 204, and further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operation flowcharts disclosed in this document. For example, the processor(s) 202 may process information in the memory(s) 204 to generate third information/signals and then transmit wireless signals including the third information/signals through the transceiver(s) 206. The processor(s) 202 may receive wireless signals including fourth information/signals through the transceiver(s) 106 and then store information obtained by processing the fourth information/signals in the memory(s) 204. The memory(s) 204 may be connected to the processor(s) 202 and store various pieces of information related to operations of the processor(s) 202. For example, the memory(s) 204 may store software code including instructions for performing all or a part of processes controlled by the processor(s) 202 or for performing the descriptions, functions, procedures, proposals, methods, and/or operation flowcharts disclosed in this document. The processor(s) 202 and the memory(s) 204 may be a part of a communication modem/circuit/chip designed to implement RAT (e.g., LTE or NR). The transceiver(s) 206 may be connected to the processor(s) 202 and transmit and/or receive wireless signals through the one or more antennas 208. Each of the transceiver(s) 206 may include a transmitter and/or a receiver. The transceiver(s) 206 may be interchangeably used with RF unit(s). In the present disclosure, the wireless device may be a communication modem/circuit/chip.

Now, hardware elements of the wireless devices 100 and 200 will be described in greater detail. One or more protocol layers may be implemented by, not limited to, one or more processors 102 and 202. For example, the one or more processors 102 and 202 may implement one or more layers (e.g., functional layers such as physical (PHY), medium access control (MAC), radio link control (RLC), packet data convergence protocol (PDCP), RRC, and service data adaptation protocol (SDAP)). The one or more processors 102 and 202 may generate one or more protocol data units (PDUs) and/or one or more service data Units (SDUs) according to the descriptions, functions, procedures, proposals, methods, and/or operation flowcharts disclosed in this document. The one or more processors 102 and 202 may generate messages, control information, data, or information according to the descriptions, functions, procedures, proposals, methods, and/or operation flowcharts disclosed in this document and provide the messages, control information, data, or information to one or more transceivers 106 and 206. The one or more processors 102 and 202 may generate signals (e.g., baseband signals) including PDUs, SDUs, messages, control information, data, or information according to the descriptions, functions, procedures, proposals, methods, and/or operation flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operation flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. For example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operation flowcharts disclosed in this document may be implemented using firmware or software, and the firmware or software may be configured to include the modules, procedures, or functions. Firmware or software configured to perform the descriptions, functions, procedures, proposals, methods, and/or operation flowcharts disclosed in this document may be included in the one or more processors 102 and 202 or may be stored in the one or more memories 104 and 204 and executed by the one or more processors 102 and 202. The descriptions, functions, procedures, proposals, methods, and/or operation flowcharts disclosed in this document may be implemented using firmware or software in the form of code, an instruction, and/or a set of instructions.

The one or more memories 104 and 204 may be connected to the one or more processors 102 and 202 and store various types of data, signals, messages, information, programs, code, instructions, and/or commands. The one or more memories 104 and 204 may be configured to include read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or wireless signals/channels, mentioned in the methods and/or operation flowcharts of this document, to one or more other devices. The one or more transceivers 106 and 206 may receive user data, control information, and/or wireless signals/channels, mentioned in the descriptions, functions, procedures, proposals, methods, and/or operation flowcharts disclosed in this document, from one or more other devices. For example, the one or more transceivers 106 and 206 may be connected to the one or more processors 102 and 202 and transmit and receive wireless signals. For example, the one or more processors 102 and 202 may perform control so that the one or more transceivers 106 and 206 may transmit user data, control information, or wireless signals to one or more other devices. The one or more processors 102 and 202 may perform control so that the one or more transceivers 106 and 206 may receive user data, control information, or wireless signals from one or more other devices. The one or more transceivers 106 and 206 may be connected to the one or more antennas 108 and 208 and the one or more transceivers 106 and 206 may be configured to transmit and receive user data, control information, and/or wireless signals/channels, mentioned in the descriptions, functions, procedures, proposals, methods, and/or operation flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received wireless signals/channels from RF band signals into baseband signals in order to process received user data, control information, and wireless signals/channels using the one or more processors 102 and 202. The one or more transceivers 106 and 206 may convert the user data, control information, and wireless signals/channels processed using the one or more processors 102 and 202 from the baseband signals into the RF band signals. To this end, the one or more transceivers 106 and 206 may include (analog) oscillators and/or filters.

Example of Use of Wireless Device to which the Present Disclosure is Applied

FIG. 9 illustrates another example of a wireless device applied to the present disclosure. The wireless device may be implemented in various forms according to a use case/service (refer to FIG. 7).

Referring to FIG. 9, wireless devices 100 and 200 may correspond to the wireless devices 100 and 200 of FIG. 8 and may be configured to include various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 and/or the one or more memories 104 and 204 of FIG. 8. For example, the transceiver(s) 114 may include the one or more transceivers 106 and 206 and/or the one or more antennas 108 and 208 of FIG. 8. The control unit 120 is electrically connected to the communication unit 110, the memory 130, and the additional components 140 and provides overall control to the wireless device. For example, the control unit 120 may control an electric/mechanical operation of the wireless device based on programs/code/instructions/information stored in the memory unit 130. The control unit 120 may transmit the information stored in the memory unit 130 to the outside (e.g., other communication devices) via the communication unit 110 through a wireless/wired interface or store, in the memory unit 130, information received through the wireless/wired interface from the outside (e.g., other communication devices) via the communication unit 110.

The additional components 140 may be configured in various manners according to type of the wireless device. For example, the additional components 140 may include at least one of a power unit/battery, input/output (I/O) unit, a driving unit, and a computing unit. The wireless device may be implemented in the form of, not limited to, the robot (100a of FIG. 7), the vehicles (100b-1 and 100b-2 of FIG. 7), the XR device (100c of FIG. 7), the hand-held device (100d of FIG. 7), the home appliance (100e of FIG. 7), the IoT device (100f of FIG. 7), a digital broadcasting terminal, a hologram device, a public safety device, an MTC device, a medical device, a FinTech device (or a finance device), a security device, a climate/environment device, the AI server/device (400 of FIG. 7), the BSs (200 of FIG. 7), a network node, or the like. The wireless device may be mobile or fixed according to a use case/service.

In FIG. 9, all of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module in the wireless devices 100 and 200 may further include one or more elements. For example, the control unit 120 may be configured with a set of one or more processors. For example, the control unit 120 may be configured with a set of a communication control processor, an application processor, an electronic control unit (ECU), a graphical processing unit, and a memory control processor. In another example, the memory 130 may be configured with a RAM, a dynamic RAM (DRAM), a ROM, a flash memory, a volatile memory, a non-volatile memory, and/or a combination thereof.

Example of Vehicle or Autonomous Driving Vehicle to which the Present Disclosure is Applied

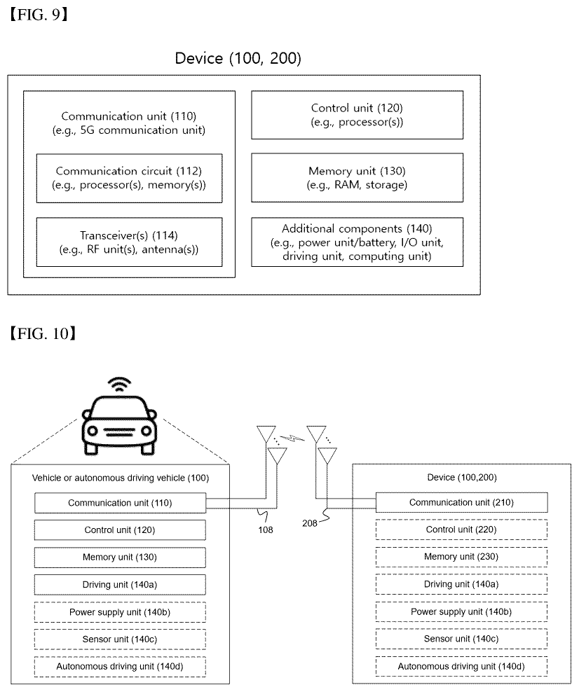

FIG. 10 illustrates a vehicle or an autonomous driving vehicle applied to the present disclosure. The vehicle or autonomous driving vehicle may be implemented as a mobile robot, a car, a train, a manned/unmanned aerial vehicle (AV), a ship, or the like.

Referring to FIG. 10, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 9, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an ECU. The driving unit 140a may enable the vehicle or the autonomous driving vehicle 100 to drive on a road. The driving unit 140a may include an engine, a motor, a powertrain, a wheel, a brake, a steering device, and so on. The power supply unit 140b may supply power to the vehicle or the autonomous driving vehicle 100 and include a wired/wireless charging circuit, a battery, and so on. The sensor unit 140c may acquire information about a vehicle state, ambient environment information, user information, and so on. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, and so on. The autonomous driving unit 140d may implement technology for maintaining a lane on which the vehicle is driving, technology for automatically adjusting speed, such as adaptive cruise control, technology for autonomously driving along a determined path, technology for driving by automatically setting a route if a destination is set, and the like.

For example, the communication unit 110 may receive map data, traffic information data, and so on from an external server. The autonomous driving unit 140d may generate an autonomous driving route and a driving plan from the obtained data. The control unit 120 may control the driving unit 140a such that the vehicle or autonomous driving vehicle 100 may move along the autonomous driving route according to the driving plan (e.g., speed/direction control). During autonomous driving, the communication unit 110 may aperiodically/periodically acquire recent traffic information data from the external server and acquire surrounding traffic information data from neighboring vehicles. During autonomous driving, the sensor unit 140c may obtain information about a vehicle state and/or surrounding environment information. The autonomous driving unit 140d may update the autonomous driving route and the driving plan based on the newly obtained data/information. The communication unit 110 may transfer information about a vehicle position, the autonomous driving route, and/or the driving plan to the external server. The external server may predict traffic information data using AI technology based on the information collected from vehicles or autonomous driving vehicles and provide the predicted traffic information data to the vehicles or the autonomous driving vehicles.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

As described above, the present disclosure is applicable to various wireless communication systems.

1. A method for performing operations of a User Equipment (UE) in a wireless communication system, the method comprising:
configuring a first semi-persistent scheduling (SPS), a second SPS, and at least one shared configured grant (CG), wherein the first SPS is associated with the at least one shared CG;
based on receiving a first medium access control (MAC) protocol data unit (PDU) on a first SPS occasion of the first SPS, transmitting a first uplink (UL) data on a CG occasion of the at least one shared CG; and
based on receiving the first MAC PDU on a second SPS occasion of the second SPS, transmitting a second UL data on a UL grant which is not given by the at least one shared CG.

2. The method of claim 1, wherein, based on the second SPS not associated with the at least one shared CG, the UL grant is a CG occasion of a dedicated CG or a dynamic UL grant.

3. The method of claim 1, wherein, based on receiving the first MAC PDU on the first SPS occasion, the first UL data is not transmitted on the uplink (UL) grant earlier than the CG occasion of the at least one shared CG.

4. The method of claim 1, wherein the first SPS and the at least one shared CG are associated with same logical channel.

5. The method of claim 1, wherein the first data is transmitted within a shared CG occupying duration for the at least one shared CG.

6. The method of claim 5, wherein the first SPS is configured with the shared CG occupying duration.

7. The method of claim 5, wherein information on the shared CG occupying duration is received with the first MAC PDU.

8. The method of claim 5, wherein CG occasions of the at least one shared CG are not used for remaining UL data after the shared CG occupying duration.

9. The method of claim 8, further comprising:
based on the remaining UL data after the shared CG occupying duration, triggering a buffer status reporting (BSR) or transmitting an indication for the remaining UL data.

10. The method of claim 5, wherein the shared CG occupying duration is configured as a number of CG occasions from the shared CG occasions.

11. The method of claim 5, wherein the shared CG occupying duration is configured as an absolute time duration.

12. The method of claim 5, wherein the shared CG occupying duration is configured as a length of at least one symbol, at least one slot, or at least one subframe.

13. The method of claim 5, wherein the shared CG occupying duration starts based on the reception of the first MAC PDU on the first SPS occasion.

14. The method of claim 5, wherein the shared CG occupying duration starts based on the transmission of the first UL data on the CG occasion of the at least one shared CG.

15. A user equipment (UE) in a wireless communication system, the UE comprising:
at least one transceiver;
at least one processor; and
at least one computer memory operably connectable to the at least one processor and storing instructions that, when executed, cause the at least one processor to perform operations comprising:
configuring a first semi-persistent scheduling (SPS), a second SPS, and at least one shared configured grant (CG), wherein the first SPS is associated with the at least one shared CG;
based on receiving a first medium access control (MAC) protocol data unit (PDU) on a first SPS occasion of the first SPS, transmitting a first uplink (UL) data on a CG occasion of the at least one shared CG; and
based on receiving the first MAC PDU on a second SPS occasion of the second SPS, transmitting a second UL data on a UL grant which is not given by the at least one shared CG.

16.-18. (canceled)

19. A base station (BS) in a wireless communication system, the BS comprising:
at least one transceiver;
at least one processor; and
at least one computer memory operably connectable to the at least one processor and storing instructions that, when executed, cause the at least one processor to perform operations comprising:
configuring, to a user equipment (UE), a first semi-persistent scheduling (SPS), a second SPS, and at least one shared configured grant (CG), wherein the first SPS is associated to the at least one shared CG;
based on transmitting a first medium access control (MAC) protocol data unit (PDU) on a first SPS occasion of the first SPS, receiving a first uplink (UL) data on a CG occasion of the at least one shared CG; and
based on transmitting the first MAC PDU on a second SPS occasion of the second SPS, receiving a second UL data on a UL grant which is not given by the at least one shared CG.
